(19) United States
(12) Patent Application Publication
(10) Pub. No.: US 2024/0046216 A1
(43) Pub. Date: Feb. 8, 2024

(54) SEARCH SYSTEM AND METHOD TO IDENTIFY RESOURCES FOR CONNECTIONS OF A MEMBER IN AN ONLINE SERVICE

(71) Applicant: Microsoft Technology Licensing, LLC, Redmond, WA (US)

(72) Inventors: Wenqiong Liu, San Francisco, CA (US); Jason Po Shen Wang, Milpitas, CA (US); Yiyuan Tu, Sunnyvale, CA (US); Sandeep D. Abhyankar, Fremont, CA (US)

(21) Appl. No.: 17/881,082

(22) Filed: Aug. 4, 2022

(51) Int. Cl. G06Q 10/10; G06F 16/903

(52) U.S. Cl. CPC G06Q 10/1053; G06F 16/90335; G06Q 50/01

(57) ABSTRACT

Methods, systems, and computer programs are presented for creating notifications for resources shared or posted by connections of a member. One method includes an operation for accessing databases to collect member information that includes first-degree connections and information about each first-degree connection. Further, a list of first-degree connections is stored in a data store with information about each first-degree connection. The method further includes operations for detecting a resource associated with a first member, and for accessing the data store to obtain network connections (first- and second-degree connections) of the first member. For each network connection of the first member, the method determines if the resource is relevant for the network connection based on the retrieved member information. Further, the method includes generating a notification about the resource for one or more of the network connections based on a relevance of the resource to the network connection.

### CROSS-REFERENCE TO RELATED APPLICATIONS

This application is related by subject matter to U.S. patent application Ser. No. ______ (Attorney Docket No. 3080.039US1) filed on the same day as the instant application and entitled “System and Method for Finding Resources Associated with Member's Connections in Real Time”, which is incorporated herein by reference in its entirety.

### TECHNICAL FIELD

The subject matter disclosed herein generally relates to methods, systems, and machine-readable storage media for presenting job postings in an online service.

### BACKGROUND

Oftentimes, job seekers do not hear back from companies when applying to jobs. It is widely known that a personal introduction to the hiring team improves considerably the chances of getting hired: a LinkedIn internal survey shows that around 50% of the job seekers reach out to people who might be hiring (e.g., the seekers' first-degree connections), or people who might know someone who is hiring (e.g., the seekers' second-degree connections) during job seeking to get help from their network. However, many job seekers mention that their primary challenge to leverage their network when finding a job is that it is difficult to find out who is hiring, or know someone who is hiring, in their network.

In an online service with more than eight hundred million members, the number of connections for a member, just considering first- and second-degree connections, can reach a million members or more. Exploring the job posts offered by a million connections for eight hundred million members, and being able to show job posts in real time (e.g., within a few seconds from receiving a request) is a complex problem that requires large amounts computing resources.

### BRIEF DESCRIPTION OF THE DRAWINGS

Various of the appended drawings merely illustrate example embodiments of the present disclosure and cannot be considered as limiting its scope.

FIG. 1 is a screenshot of a member feed, according to some example embodiments.

FIG. 2 is a user interface (UI) for presenting notifications, according to some example embodiments.

FIG. 3 is a UI for presenting job posts, according to some example embodiments.

FIG. 4 is a UI for presenting details of the job post, according to some example embodiments.

FIG. 5 illustrates the data schema for storing member's connections, according to some example embodiments.

FIG. 6 illustrates the process for retrieving member's connections, according to some example embodiments.

FIG. 7 illustrates the flow of information for retrieving the member's connections, according to some example embodiments.

FIG. 8 is a block diagram illustrating a networked system, according to some example embodiments, including a social networking server, illustrating an example embodiment of a high-level client-server-based network architecture.

FIG. 9 illustrates the training and use of a machine-learning model, according to some example embodiments.

FIG. 10 is a flowchart of a method for creating notifications for job posts shared or posted by connections of a member, according to some example embodiments.

FIG. 11 is a block diagram illustrating an example of a machine upon or by which one or more example process embodiments described herein may be implemented or controlled.

### DETAILED DESCRIPTION

Example methods, systems, and computer programs are directed to creating notifications for job posts shared or posted by connections of a member. As used herein, the term “member” refers to any user that accesses an online service, even though some users may have not gone through the registration process with the online service. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A graph is a collection of points and lines connecting some of the points. The points of a graph are also known as vertices or nodes, and the lines are also known as edges or arcs. Graphs are useful to model many real-life scenarios, like people's connections on a social network, tracking infections on a pandemic, finding resources on a network, finding the best route using public transportation, etc.

Typically, a graph can be stored on a computing system by storing in a database the nodes of the graph and all the edges connecting the nodes. To obtain information from the graph, the computing device traverses the vertices and nodes to get to a particular answer. For example, to find some information for a node on the graph (e.g., connections of a person living within 100 Km), the computing device has to explore all the edges of the node, and then explore the connections of the connections, and so forth, depending on how “deep” the search for the answer goes.

In large graphs, recursively exploring the graph can become quickly very expensive in terms of the amount of computing resources that are needed. There is a popular theory of the seven degrees of separation, where any two people in the world are separated by at most seven connections connecting one person (acquaintance, friend, relative, or other) to another. Thus, going to a recursive search of seven would potentially find all people in a social network that may cover billions of people.

But even just exploring first- and second-degree connections can be an expensive problem in terms of the amount of computing resources that are needed. For example, the online network LinkedIn® has more than 800 million members, and a member may have more than a million connections between first- and second-degree connections. In another example, searching for resources on a network may also require exploring millions or billions of nodes since it is estimated that the Internet includes about 12 billion connected devices.

Typically, the graph is stored in a database and information about the nodes is stored in another database. For example, a graph may include the nodes connected on a network, and a second database includes information for each of the nodes, such as hardware and software installed, available peripherals, available gateway connections, etc. A search for an item associated with a node will require traversing the graph and then making a call for each node to the second database to obtain the information for the node. The traversal of the graph may be expensive (in terms of computing resources) given the exponential growth of nodes as the search goes deeper into deeper connections. If the traversal requires analyzing data for a million nodes or more, this means a million calls to the second database.

Typically, when trying to provide answers in online systems (e.g., providing an answer in 500 ms or less), the aforementioned approach would not work most of the times given the expensive operation to traverse the graph and all the separate database access calls required to obtain the data for the nodes.

Modern data processing systems can be classified as online, nearline, and offline. Online systems, e.g., for processing business transactions, are handled by front-end relational databases and serve results within milliseconds. Nearline systems typically operate in the order of seconds, and offline systems within minutes or hours. As companies realize the increased business and value of analyzing data with low latency, the trend is towards an increased number of resources for nearline back-end systems. Both nearline and offline systems typically ingest data from other servers and databases. As used herein, responding in real time or near real time refers to nearline systems that can respond within a few seconds from receiving a request, such as response times in a range from 50 milliseconds to five seconds.

In one aspect, a solution for extracting graph information creates a database that stores the connection information for each node of the graph, that is, a list of all the first-degree connections for each node of the graph. Also, for each connection, information about the connection node is stored so when a query is received, all the information is available in the database to be able to quickly find the connections that meet the query criteria without having to access other databases. Once the required items are found (e.g., social connections living in the same city), some additional information may be obtained but from a much smaller set of data (e.g., hundreds of items instead of millions) or additional filtering applied on the much smaller set of data. This new data structure that is created and the resultant searching method provides a new specific technical implementation that reduces the computing resources used to perform searches and the time taken to perform those searches. The implementation described herein is independent of the nature of the information that is represented by the graph.

A query is received, with an identifier of a source node, to find nodes connected to the source node that want access to a resource offered by the source node. The system searches for nodes connected to the source node in the request (e.g., first- and second-degree connections) to find the nodes that want access to the resource offered by the source node. The response to the query includes one or more of the connections that want access to the resource.

Embodiments of the invention are described with reference to a social graph that is a social network system, and the resource searched is job-posts of interest to members of the social network system. However, the same principles may be applied to other solutions, such as finding people that have been in contact with a person in the last week and that have been in locations where infected people have been found. Another solution may include finding people that went to the same high school of a member thirty years ago and that are living in Europe. Another solution may include finding friends that would like to see a restaurant review created by a member. Another solution may be finding people in a dating site that live in the same city and like to play chess. As noted above, the techniques described herein can be applied to improve the ability to search a graph that represents any type of data.

One feature of the LinkedIn online service is that members can share job posts to the community (e.g., using the feature called #Hiring) to let others know that the member's company, and more specifically the member's team, is hiring for a particular job. The job sharer may be different than the job poster, e.g., a recruiter for the same company. A job-seeking member can benefit by knowing who is hiring from his first- and second-degree connections. However, given the large number of members in the online service, it is difficult to quickly identify when a member's connection is hiring. In another example, a company of a connection may be hiring, but the connection may be completely unrelated to the job post.

In one aspect, notifications are generated in real-time for members when a connection of the member has indicated that the connection is hiring (e.g., job sharing or job posting) for a job of interest to the member. A notification is sent to the member notifying that her connection can be leveraged to get the job that matches the professional interest of the member.

In another aspect, job posts for a member are identified by searching the database of posted jobs and prioritizing based on relevance to the searching member and the availability of a direct connection (e.g., first or second degree) that has indicated to be hiring for the job post.

Further, when job posts are presented to the member, an indication is presented in the job post when a direct connection is hiring for that job post, giving the job seeker an incentive to apply for that job because the member can leverage the connection to be used as a referral.

For the purposes of this description the phrases “an online social networking application” and “an online social network system” may be referred to as and used interchangeably with the phrases “an online system,” “an online service,” “a networked system,” or merely “a connections network.” It will also be noted that a connections network may be any type of an online network, such as, e.g., a professional network, an interest-based network, or any online networking system that permits users to join as registered members. For the purposes of this description, registered members of a connections network may be referred to as simply members. Further, some connections networks provide services to their members (e.g., search for jobs, search for candidates for jobs, job postings) without being a social network, and the principles presented herein may also be applied to these connection networks.

One general aspect includes a method that includes an operation for accessing at least one database to collect member information for at least one member of an online service. The member information comprises first-degree connections of the at least one member and information about each first-degree connection. Further, the method includes an operation for storing in a data store, for the at least one member, a list of first-degree connections of the at least one member and information about each first-degree connection. The method further includes operations for detecting a resource associated with a first member in the online service, and for accessing the data store to obtain network connections of the first member. The network connections comprise first-degree connections and second-degree connections of the first member. The accessing comprises operations to obtain the list of first-degree connections of the first member, obtaining the lists of first-degree connections of the first-degree connection from the data store, and generating a list of second degree-connections of the first member based on the lists of first-degree connections of the first-degree connections. For each network connection of the first member, the method includes determining if the resource is relevant for the network connection based on the member information retrieved from the data store. Further, the method includes an operation for generating a notification about the resource for one or more of the network connections based on a relevance of the resource to the network connection.

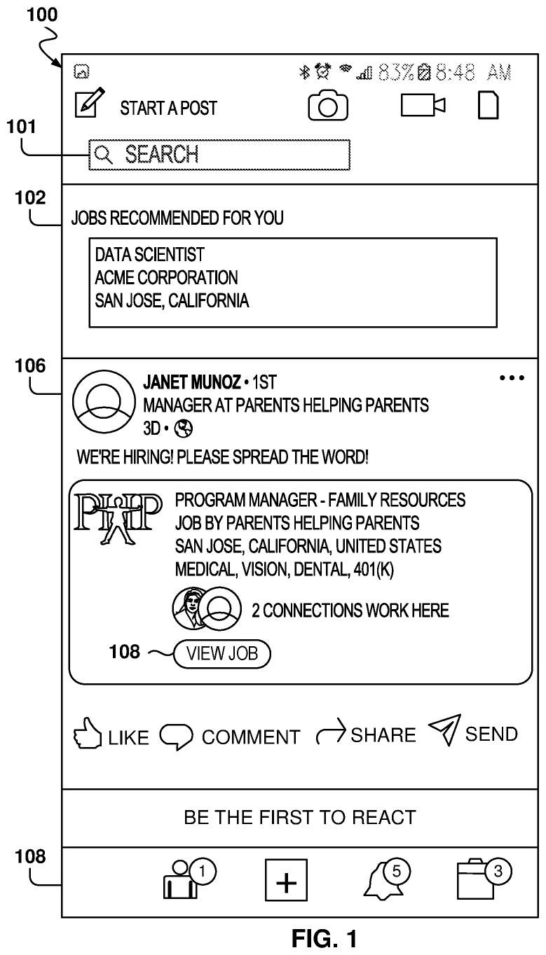

FIG. 1 is a screenshot of a member feed 100, according to some example embodiments. The member feed 100 may include items in different categories, such as search field 101, job recommendations 102, job post 106, sponsored items, shortcuts 108, news, messages, articles, etc.

In one example embodiment, a social network service user interface provides the job recommendations 102 that match the job interests of the member and that are presented without a specific job search request from the member, referred to herein as “jobs you may be interested in” (JYMBII). In other example embodiments, the member feed 100 includes suggestions or recommendations (not shown) for adding new connections, a feature referred to herein as People You May Know (PYMK).

The job post 106 includes information about a job post that has been shared or posted by a connection of the member. A member using the #Hiring feature indicates that the member, or the company of the member, is hiring on the online service to attract qualified candidates taking advantage of the member's network. The member can share that the member is #Hiring in multiple ways, such as adding to the member's profile, adding on the homepage of the member, creating a job post with the #Hiring tag, using the #Hiring photo frame on the profile photo, sending messages to other members, etc. The member may also invite coworkers to share the job and add the #Hiring photo frame to their profile photo.

The job post 106 provides information on the company hiring and the member's connection (e.g., first-degree connection, second-degree). The member may select the job post and then find more information about the job post.

Other member posts may include items posted by members of the social network service (e.g., items posted by connections of the member), and may be videos, comments made on the social network, pointers to interesting articles or webpages, etc.

Additionally, the member may receive in-network communications from other members. The communications may originate by other members who are socially connected with the member or by unconnected members.

In some example embodiments, shortcuts 108 are provided in the feed 100, such as links for accessing the homepage, access members in my network, add a post, notifications, and jobs. As used herein, a notification is a message sent to the member. The notification may be sent in multiple ways, such as a message within an application executing on a computing device, a notification sent to a device (e.g., notification presented on a mobile phone), an email sent to the member, a text message, a WhatsApp message, a message on a social network, etc.

In some example embodiments, the shortcuts 108 include links for accessing the homepage, access members in my network, add a post, notifications, and jobs. The icons in the shortcuts 108 area include notification counters presented within a circle next to the icon. In the illustrated example, there is one message from the member's network, six app notifications, and three job suggestions.

An example of a notification is a message indicating that a network connection is hiring for a job that matches the member's skills and requirements for a new job. Another example of a notification is a message regarding people you may know (PYMK) suggesting a new connection on the online service. Another type of notification is a new job that may be interesting for the member.

In general, job seekers want to use their network to find new jobs because having an inside connection greatly improves the chances of landing the new job. As used herein, embodiments refer to the network of a member as first- and second-degree connections, but the principles presented may also be applied to just first-degree connections, or first to third degree, first to fourth degree, etc.

Members find it challenging to find jobs offered by their connections given the large number of jobs in the online service. Also, a large company (e.g., Microsoft), may be offering hundreds of jobs. Although the member may have a connection at Microsoft, this does not mean that the connection is related to a particular job post (e.g., the job may be in another division or in another country).

Additionally, it has been observed that even members that are not active seekers are interested in being notified about jobs in their first-degree network, and the primary reason is the belief that “I may casually find a job opportunity that interests me.”

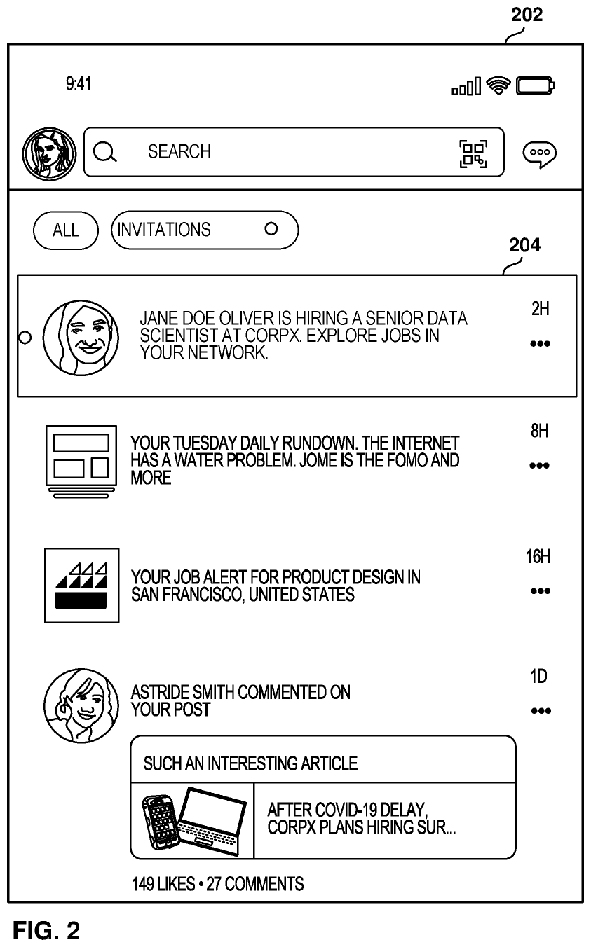

FIG. 2 is a user interface (UI) 202 for presenting notifications, according to some example embodiments. A recruiter posting a new job (using #Hiring frame) is able to reach potential job candidates. Also, a member may share a job post using #Hiring to indicate that his company is hiring in a job associated with the member, such as the group or organization of the member inside the company. In some example embodiments, a job-seeking-intent score (JSIC) is used to limit notifications to job seekers that are actively looking for a new job, but other embodiments may also send to people not actively looking, e.g., the job is a good match for the member's skills and has been shared by a first-degree connection.

The JSIC is based on the member's activities regarding job searches, job-title match, and the open-to-work feature enabled in the member's profile. Notifications are then sent if the JSIC is above a predetermined threshold. Different notifications may be sent depending on the degree and strength of a connection and the relevance of the job post to the member. As soon as the job poster adds or shares a job post to their profile, the network connections will receive the job notification in near real time.

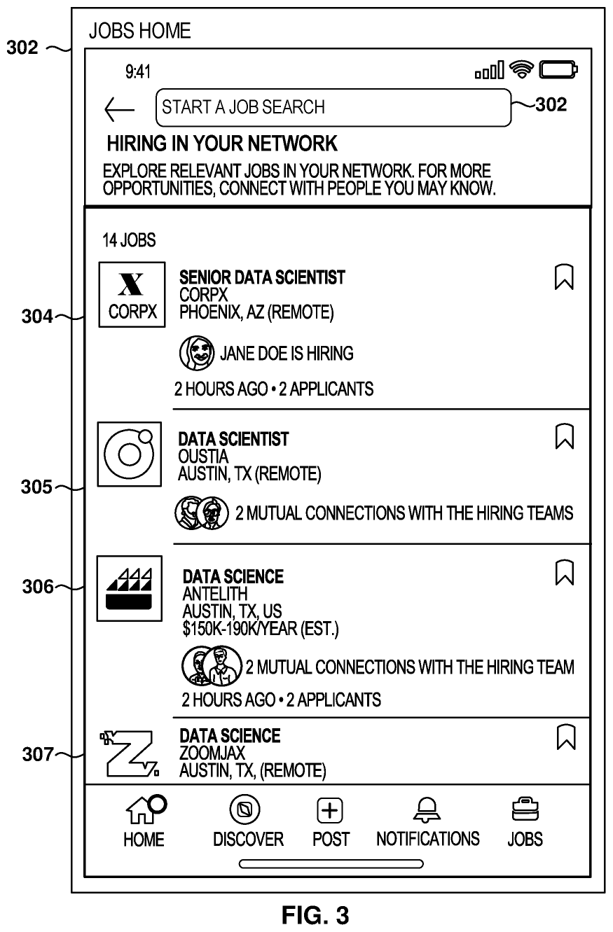

The UI 202 includes a list of notifications 204. For example, a connection named Jane Doe is hiring a Senior Data Scientist at CorpX, and the connection is part of the member's network. Once the member clicks into the notification 204, a list of relevant job posts are presented, such as the example described below with reference to FIG. 3.

FIG. 3 is a UI 302 for presenting job posts, according to some example embodiments. When the member accesses the jobs UI 302, the online service selects the relevant job posts for the member based on several factors, such as the relevance of the job post to the member's profile, connection strength between the member and the person sharing or posting, job location, job title, skills required, etc.

The UI 302 presents the list of job posts 304-307 based on their relevance to the member. For example, job post 304 corresponds to the notification 204 sent to the member, as shown in FIG. 2. The job posts that are offered by the member's network also shows the connection of the member associated with the job post. For example, the job post 304 shows that a connection of the member, Jane Doe, is hiring.

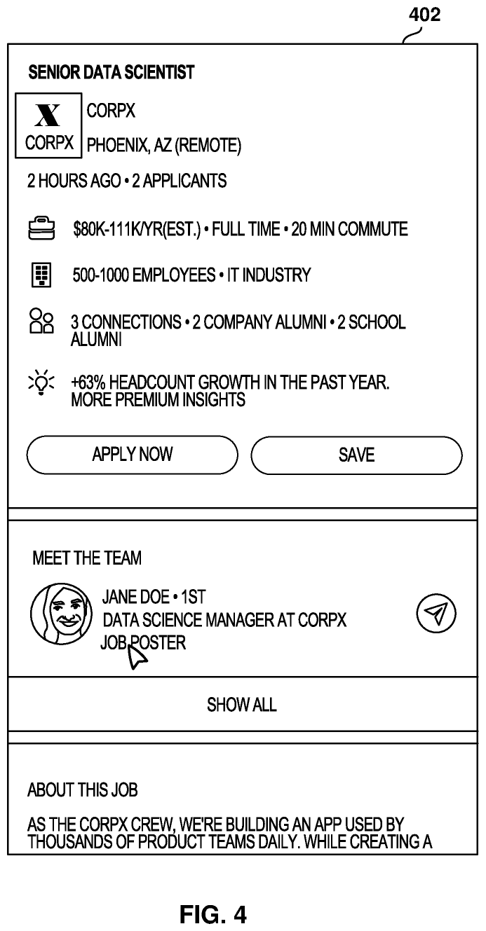

FIG. 4 is a UI 402 for presenting details of the job post, according to some example embodiments. When the member clicks on the job post 304 of the UI 302, the details of the job post are presented in UI 402.

The job details include information about the location, the expected salary, the company, number of connections in the company, and the connections that are sharing the job post, such as Jane Doe in this example, who is a first-degree connection of the member. Further, a job description is included. If the member had more connections sharing the job post 304, the additional connections would also be presented.

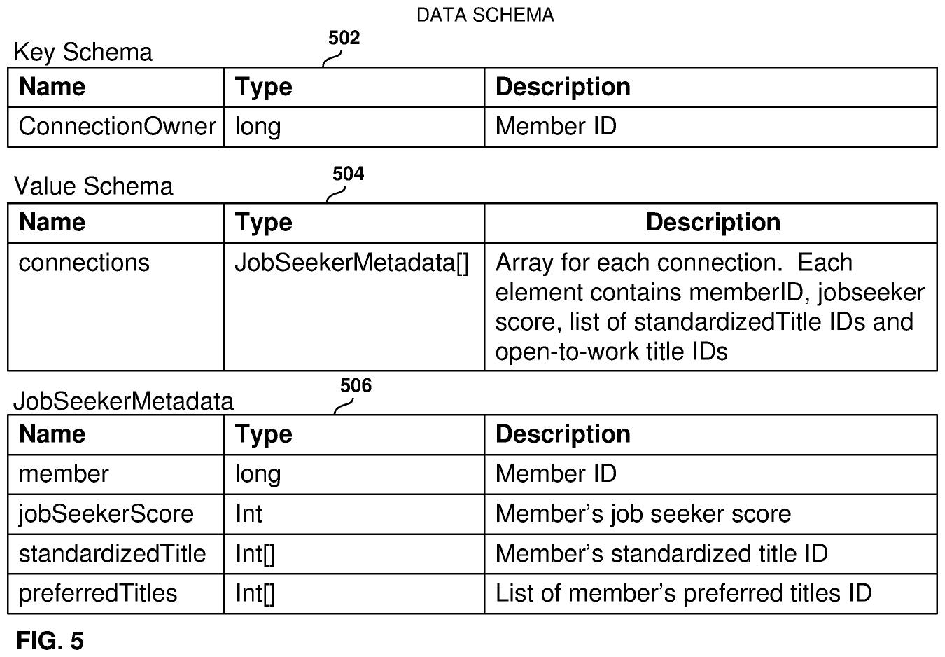

FIG. 5 illustrates the data schema for storing member's connections, according to some example embodiments. The social network LinkedIn has more than 800 million members. A member may have more than a million network connections just considering first- and second-degree connections. Thus, finding the job posts offered by the member's connections, and sending notifications in real time can be very expensive in terms of computing resources and time.

To address this problem, a new connections data storage (CDS) has been designed to handle this volume. The requirements for CDS include ability to fetch a member's first-degree connections in real time (e.g., within a period between 10 and 500 ms, but other time ranges are also possible), ability to fetch any member's second degree connections in real time, ability to retrieve a large volume (e.g., in the order of millions of items) of connection's derived data in real time (e.g., job seeker score, standardized title identifier (ID), open-to-work title IDs), ability to add new metadata per connection if needed, ability to refresh connection data daily, and ability to filter the candidates based on selection criteria (e.g., job-seeker score).

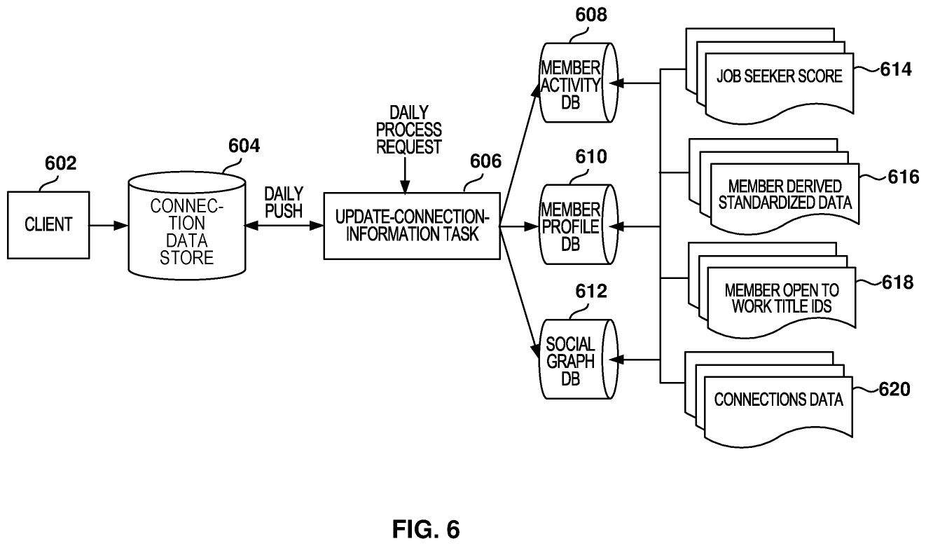

To solve the problem, CDS accesses several databases to gather information related to the members and the job posts, CDS organizes the information, and then CDS stores the information in new data structures so CDS can respond to the query in real time. More details about the data gathering are provided below with reference to FIG. 6. While the following description refers to job-posts, these are one example of a resource that may be offered (or sponsored) by or otherwise associated with a member.

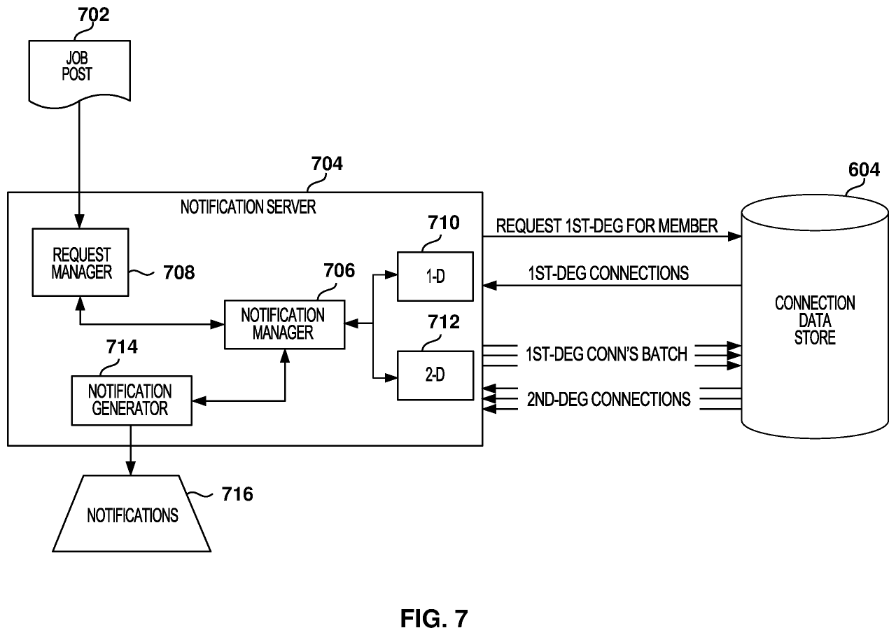

When a new job-post is sponsored by a member, referred to as the sponsoring member, CDS traverses the connections of the sponsoring member to obtain the first-degree connections. The process may be repeated to obtain the second-degree connections. In other examples, the third-degree connections may be obtained from the second-degree connections. In other examples, the fourth-degree connections may be obtained from the third-degree connections. More details about the traversal of the graph are provided below with reference to FIG. 7.

CDS has enough information to determine if each connection would be a good match for sending a notification for the job post, based on the cached data of the connection in CDS and the characteristics of the job post. That is, there is no need to access the member profile database in order to determine if the job-post is a match for the member.

For the general framework of the technical solution, the graph is the online service social graph with vertices being the members of the online service and the edges being the existing connections in the online service. Further, the resource is the job post that is analyzed to determine if the job post matches the job posts that the connection would want to see.

In some example embodiments, a notification is created for a member whenever a member's connection posts a new job post or shares the job post to their profile via #Hiring. CDS handles one-to-many relationships for first- and second-degree connections.

In traditional technical approaches, to find the job posts within the member's network connections, the system made multiple requests for each single job poster's job, once for each connection, to downstream servers that hold graph information for the connections on the online service. However, this approach results in an exponential burst of requests to the downstream servers, because a request has to be made for each connection to obtain the second-degree connection and because a request has to be made for each member to obtain the job posts shared or posted by the member.

To avoid having to generate so many requests, CDS uses a new data schema to store connection information so a determination can be made in near real time on whether a job post is relevant to a network connection. In some example embodiments, CDS utilizes Venice, a proprietary derived-data, key-value storage platform, designed to keep track of member's connection data. But other embodiments may use other types of databases based on the principles presented herein.

Venice supports the data source from both ETLs and streaming, which reduces the complexity of applications. Also, Venice reduces the latency issue by supporting stream data sources and is highly scalable and reliable. Some of the Venice components include a controller, storage nodes, and a router. The controller controls the assignment of the storage notes and provides version control. The storage nodes are the places where the data is stored, and the router provides an Application Programming Interface (API) to provide access to external systems.

CDS is designed to keep track of the members' connection data, plus some additional metadata about the connections, such as job-seeker score, the preferred title, and the standardized title.

The data schema for CDS is presented in FIG. 5 and includes three tables for one example embodiment. Table 502 is for the key schema that has one parameter ConnectionOwner that holds the member ID of the member whose connections are stored. In this example, the member ID is a variable of type Long (long integer).

The table 504 is for storing the value schema and includes a parameter called connections that holds information about the connections of the member. The array connections is of type JobSeekerMetadata[ ], which is described in table 506, and holds, for a given member ID, a row for each connection.

As seen in table 5-6, the JobSeekerMetadatail contains the member ID of the connection (with type long), the job-seeker score (type integer), a list of title IDs of the connection standardizedTitle (a vector of integers), and open-to-work title IDs of the connection referred to as preferredTitles (a vector of integers). The JobSeekerMetadatail is used to determine if the job-post is a match without requiring access to other databases. More details about matching the member to the job post are provided below with reference to FIG. 7. More generally where the resource is not a job-post, this metadata is used to determine if the resource is a match without requiring access to other databases.

The job-seeker score is a number that indicates a probability that the member is currently job seeking (or, more generally, a probability that the member is currently seeking a resource). The lower the job-seeker score (JSS) is, the more likely it is that the member is actively searching for a new position, e.g., a JSS of 1 means that the member is an urgent job seeker, and a JSS of 2 means that the member is an open-to-work member. Open-to-work is a feature where a member can flag her profile to indicate that the member is actively looking for job, such as by using the #OpenToWork hashtag. This serves as a flag for recruiters and connections to know that the member is searching, and the member has the ability to control who can see the #OpenToWork hashtag. The member can specify the types of job opportunities of interest, the preferred location, etc. The open-to-work title ID is the title, or titles, that the member has identified as being of interest for a new job opportunity. That is, the preferred title ID may be different than the current title ID of the member.

When a new job post is shared or posted, the data stored in CDS is enough to make an initial determination if the job post is of interest to a member connection (or more generally, when a new resource is shared, posted or otherwise made available, the data stored in CDS is sufficient to enable an initial determination to be made whether the resource should be notified to a member connection). That is, the possible one million connections can be examined quickly to reduce the number of possible notifications to a small set of connections. The notifications can then be generated for these connections. Additionally, the small set of connections may then be further filtered by checking other parameters, such as relevance of the job post to the member, and the list of possible connections can be further reduced based on the relevance to ensure that members are not spammed by irrelevant notifications.

It is noted that the embodiments illustrated in FIG. 5 are examples and do not describe every possible embodiment. Other embodiments may utilize different types of variables, variables of different sizes, additional information about connections, etc. The embodiments illustrated in FIG. 5 should therefore not be interpreted to be exclusive or limiting, but rather illustrative.

FIG. 6 illustrates the process for retrieving member's connections, according to some example embodiments. The data for CDS is derived from the existing connection data in the offline service.

In some example embodiments, an update-connection-information task 606 is triggered to obtain the data from the social graph database (DB) 608. The update-connection-information task 606 makes requests for information from a member activity DB 608, a member profile DB 610, and a social graph DB 608 and the information is used to generate the data stored in CDS 604. In some example embodiments, the metadata collected for each connection includes the job-seeker score 614, member derived standardized data 616 (e.g., standardized title ID), open-to-work title IDs 618, and connections data 620. The update-connection-information task 606 may be triggered to execute on demand, or may be executed periodically, such as every day.

Once the data is stored in CDS, a client 602 can obtain connection information from CDS 604 very quickly in order to generate notifications for new resources, such as new job posts. For example, a notification can be sent within seconds after a new job post is added to the online service. The data for CDS is updated periodically, such as daily, to keep the connection data fresh.

Thus, CDS can fetch first- and second-degree connections of a member in near real time because the data has already been organized to have the information about first-degree connections readily available. The data for second-degree connections is then obtained by repeating the process (e.g., in an iterative manner) and getting the first-degree connections of the first-degree connections. CDS retrieves the information for this member's connections, such as the job-seeker score, etc., that are already stored as described above with reference to FIG. 5.

FIG. 7 illustrates the flow of information for retrieving the member's connections, according to some example embodiments. A notification server 704 includes several modules related to the generation of notifications. The notification server 704 includes a request manager 708, a notification manager 706, a 1-D module 710, a 2-D module 712, and a notification generator 714.

The notification manager 706 coordinates the activities related to the generation of notifications for job posts shared or posted. A new job post 702 (posted or shared) triggers a request for notifications.

The request manager 708 provides an interface to receive the request for notifications. Upon receiving the request, the notification manager 706 initializes the process to get first- and second-degree connections for the member (or members) that have posted or shared the job post 702. The 1-D module 710 collects the first-degree connections, and the 2-D module 712 obtains the second-degree connections.

The 1-D module 710 sends a request to the CDS 604 for the first-degree connections of a member with a given member ID, and the CDS returns the first-degree connections for that member ID.

The 2-D module 712 obtains the second-degree connections by obtaining the first-degree connections of the first-degree connections of the member. Since there may be millions of second-degree connections, the process can be broken into a plurality of calls to obtain the second-degree connections, and each call obtains the connections of a set of the first-degree connections. The 2-D module 712 makes the batch of calls for the first-degree connections to the CDS 604 to obtain the second-degree connections. The information for the network connections includes the metadata for each connection, such as the metadata described in FIG. 5.

The call for connections of connections may happen multiple times to avoid having a high number of returns (e.g., millions). In some example embodiments there is a limit of first-degree connections sent in the request for second-degree connections, such as a maximum of 200 first-degree connections, but other embodiments may use a different limit, such as a limit in the range from 5 to 500. Thus, the higher the number of first-degree connections, the more calls will be made for the second-degree connections.

The second-degree connections are then consolidated (e.g., deduplicated) because there could be second-degree connections through more than one first-degree connection. For example, if first-degree connections F₁ and F₂₅ both have a connection of S₅₇, S₅₇ would appear twice as a second-degree connection. The consolidation process guarantees that there are no repetitions in the list of second-degree connections so S₅₇ would appear only once.

The same process can be interactively repeated if the system implemented and expanded the network to higher degrees, such as using third-degree connections.

The notification generator 714 generates the #Hiring notifications 716 for new job posts for a member using the information for first- and second-degree connections. For each connection, a decision is made to send a notification for the job post 702 based on the metadata for the connection: job-seeker score, list of standardized title IDs, and list of preferred title IDs.

A check is made to determine if the job-seeker score is below a predetermined threshold for job-seeker scores, e.g., these members are actively or casually job seeking. If the job-seeker score is above the predetermined threshold, then the notification is not generated. That is, the notifications are not generated if the member is not actively or casually seeking new job opportunities.

If the job-seeker score is below the predetermined threshold, then a check is made to see if the standardized title in the job post 702 matches any from the list of standardized title IDs or list of preferred title IDs of the connection. If a title ID matches, then the notification 716 is generated for that member.

In some example embodiments, additional filtering may be performed for the generated notifications. A relevance score may be used to calculate a relevance of the job post 702 to the connection based on the job post 702 information and the connection information (e.g., profile information, activity information). The relevance score may then be used to determine if the notification should be sent out if the relevance score is above a predetermined threshold for relevance scores.

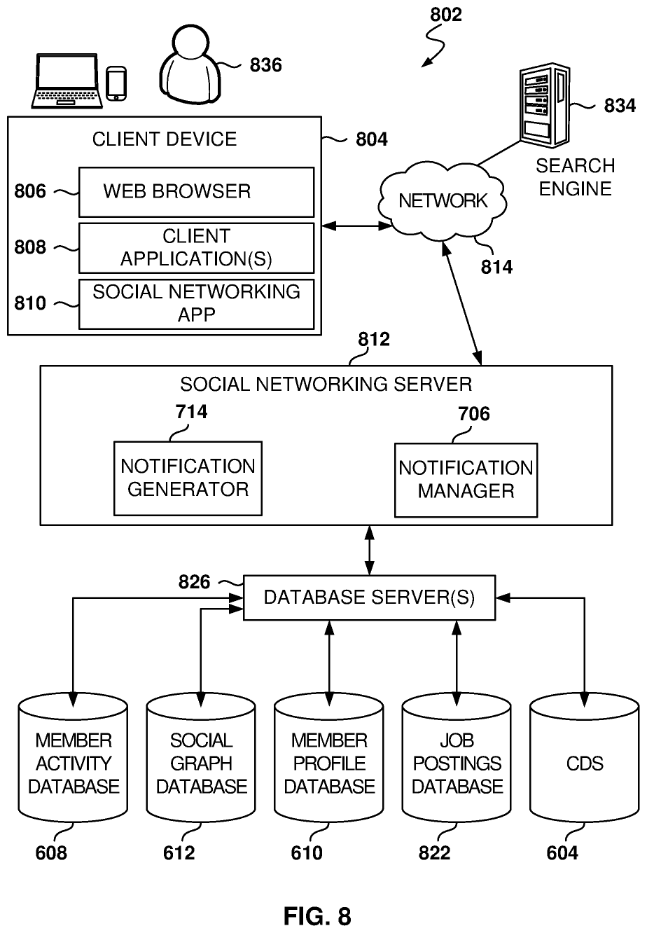

FIG. 8 is a block diagram illustrating a networked system, according to some example embodiments, including a social networking server 812, illustrating an example embodiment of a high-level client-server-based network architecture 802. Embodiments are presented with reference to an online service, and, in some example embodiments, the online service is a social networking service.

The social networking server 812 provides server-side functionality via a network 814 (e.g., the Internet or a wide area network (WAN)) to one or more client devices 804. FIG. 8 illustrates, for example, a client device 804 with a web browser 806, client application(s) 808, and a social networking app 810 executing on the client device 804. The social networking server 812 is further communicatively coupled with one or more database servers 826 that provide access to one or more databases 608, 612, 610, 822, and 604.

The social networking server 812 includes, among other modules, the notification generator 714 and the notification manager 706. The notification generator 714 creates notifications with messages for members of the online service. The notification manager 706 coordinates the different activities regarding notifications for members of the online service and sends the notifications to the members.

The client device 804 may comprise, but is not limited to, a mobile phone, a desktop computer, a laptop, a tablet, a netbook, a multi-processor system, a microprocessor-based or programmable consumer electronic system, or any other communication device that a member 836 may utilize to access the social networking server 812. In some embodiments, the client device 804 may comprise a display module (not shown) to display information (e.g., in the form of user interfaces).

In one embodiment, the social networking server 812 is a network-based appliance that responds to initialization requests or search queries from the client device 804. One or more members 836 may be a person, a machine, or other means of interacting with the client device 804. In various embodiments, the member 836 interacts with the network architecture 802 via the client device 804 or another means.

In some embodiments, if the social networking app 810 is present in the client device 804, then the social networking app 810 is configured to locally provide the user interface for the application and to communicate with the social networking server 812, on an as-needed basis, for data and/or processing capabilities not locally available (e.g., to access a member profile, to authenticate a member 836, to identify or locate other connected members 836, etc.). Conversely, if the social networking app 810 is not included in the client device 804, the client device 804 may use the web browser 806 to access the social networking server 812.

In addition to the client device 804, the social networking server 812 communicates with the one or more database servers 826 and databases. In one example embodiment, the social networking server 812 is communicatively coupled to a member activity database 608, a social graph database 612, a member profile database 610, a job postings database 822, and the CDS 604. The databases may be implemented as one or more types of databases including, but not limited to, a hierarchical database, a relational database, an object-oriented database, one or more flat files, or combinations thereof.

The member profile database 610 stores member profile information about members 836 who have registered with the social networking server 812. With regard to the member profile database 610, the member 836 may be an individual person or an organization, such as a company, a corporation, a nonprofit organization, an educational institution, or other such organizations. The social graph DB 612 contains the connections between members in the online service, that is, for each member, a list of connections of the member are stored in the social graph DB 612.

In some example embodiments, when a member 836 initially registers to become a member 836 of the social networking service provided by the social networking server 812, the member 836 is prompted to provide some personal information, such as name, age (e.g., birth date), gender, interests, contact information, home town, address, spouse's and/or family users' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 610. Similarly, when a representative of an organization initially registers the organization with the social networking service provided by the social networking server 812, the representative may be prompted to provide certain information about the organization, such as a company industry.

As members 836 interact with the social networking service provided by the social networking server 812, the social networking server 812 is configured to monitor these interactions. Examples of interactions include, but are not limited to, commenting on posts entered by other members 836, viewing member profiles, editing or viewing a member's own profile, sharing content outside of the social networking service (e.g., an article provided by an entity other than the social networking server 812), updating a current status, posting content for other members 836 to view and comment on, posting job suggestions for the members 836, searching job postings, and other such interactions. In one embodiment, records of these interactions are stored in the member activity database 816, which associates interactions made by a member 836 with his or her member profile stored in the member profile database 610.

The job postings database 822 includes job postings offered by companies. Each job posting includes job-related information such as any combination of employer, job title, job description, requirements for the job posting, salary and benefits, geographic location, one or more job skills desired, day the job posting was posted, relocation benefits, and the like.

While the database server(s) 826 are illustrated as a single block, one of ordinary skill in the art will recognize that the database server(s) 826 may include one or more such servers. Accordingly, and in one embodiment, the database server(s) 826 implemented by the social networking service are further configured to communicate with the social networking server 812.

The network architecture 802 may also include a search engine 834. Although only one search engine 834 is depicted, the network architecture 802 may include multiple search engines 834. Thus, the social networking server 812 may retrieve search results (and, potentially, other data) from multiple search engines 834. The search engine 834 may be a third-party search engine.

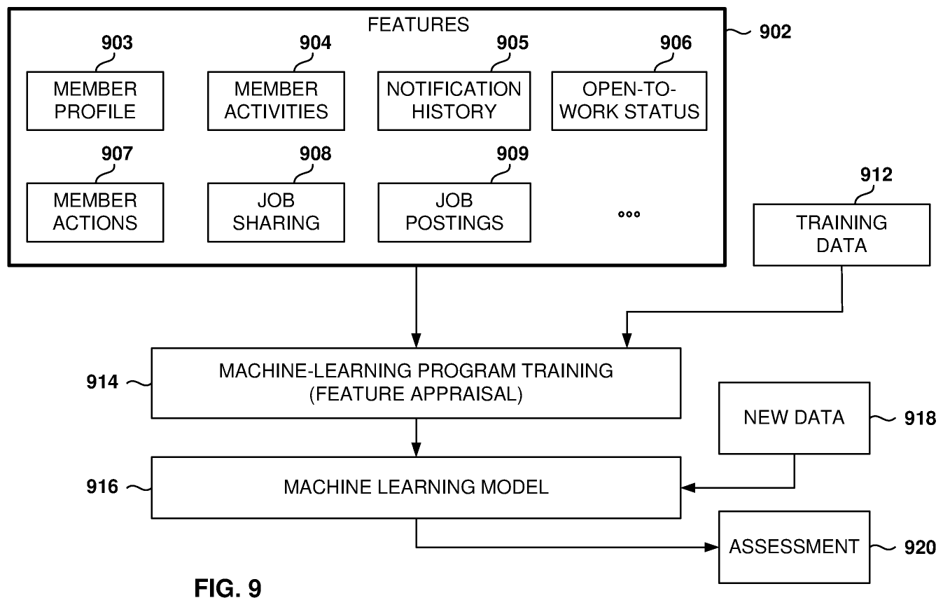

FIG. 9 illustrates the training and use of a machine-learning model, according to some example embodiments. In some example embodiments, machine-learning (ML) models 916, are utilized to calculate the job-seeker score and to calculate the job-affinity score of a job post for a member.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 916 from example training data 912 in order to make data-driven predictions or decisions expressed as outputs or assessments 920. Although example embodiments are presented with respect to a few machine-learning tools, the principles presented herein may be applied to other machine-learning tools.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some example embodiments, the job-seeker score is the probability that the member is currently job seeking. In some embodiments, example ML model 916 provide a job affinity score (e.g., a number from 1 to 100) to qualify each job as a match for the member (e.g., calculating the job affinity score).

The training data 912 comprises examples of values for the features 902. In some example embodiments, the training data comprises labeled data with examples of values for the features 902 and labels indicating the outcome, such as member applied for the job, member requested details for the job, member responded to a notification, etc. The machine-learning algorithms utilize the training data 912 to find correlations among identified features 902 that affect the outcome. A feature 902 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 902 may be of different types and may include one or more of member profile information 903, member activity information 904 (e.g., articles read, jobs applied to, connections made, articles posted, jobs posted), notification history 905, open-to-work status 906, member actions 907, jobs shared 908, job postings 909, etc.

During training 914, the ML program, also referred to as ML algorithm or ML tool, analyzes the training data 912 based on identified features 902 and configuration parameters 911 defined for the training. The result of the training 914 is the ML model 916 that is capable of taking inputs to produce assessments.

Training an ML algorithm involves analyzing large amounts of data (e.g., from several gigabytes to a terabyte or more) in order to find data correlations. The ML algorithms utilize the training data 912 to find correlations among the identified features 902 that affect the outcome or assessment 920. In some example embodiments, the training data 912 includes labeled data, which is known data for one or more identified features 902 and one or more outcomes.

The ML algorithms usually explore many possible functions and parameters before finding what the ML algorithms identify to be the best correlations within the data; therefore, training may make use of large amounts of computing resources and time.

When the ML model 916 is used to perform an assessment, new data 918 is provided as an input to the ML model 916, and the ML model 916 generates the assessment 920 as output. For example, a job-seeker score is calculated as the assessment 920 when the member ID is used as an input. In another example, a job-affinity score is calculated as the assessment 920 when the inputs of job post ID and member ID are provided.

In some example embodiments, results obtained by the model 916 during operation (e.g., assessments 920 produced by the model in response to inputs) are used to improve the training data 912, which is then used to generate a newer version of the model. Thus, a feedback loop is formed to use the results obtained by the model to improve the model.

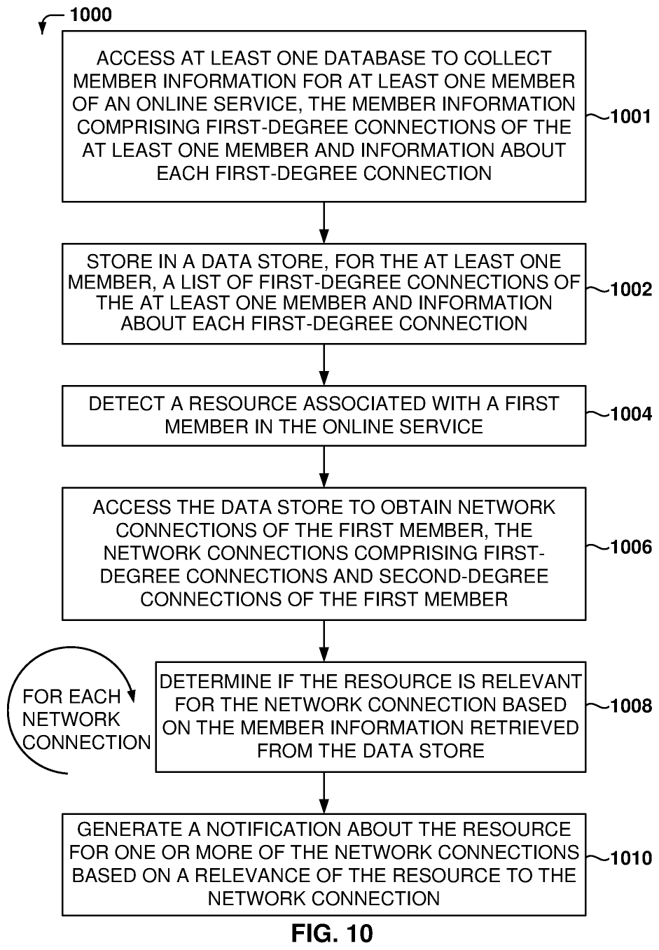

FIG. 10 is a flowchart of a method 1000 for creating notifications for resources shared or posted by connections of a member, according to some example embodiments. While the various operations in this flowchart are presented and described sequentially, one of ordinary skill will appreciate that some or all of the operations may be executed in a different order, be combined or omitted, or be executed in parallel.

Operation 1001 is for accessing at least one database to collect member information for at least one member of an online service, the member information comprising first-degree connections of the at least one member and information about each first-degree connection.

From operation 1001, the method 1000 flows to operation 1002 is for storing in a data store, for at least one member, a list of first-degree connections of the at least one member and information about each first-degree connection.

From operation 1002, the method 1000 flows to operation 1004 for detecting a resource associated with a first member in the online service.

From operation 1004, the method 1000 flows to operation 1006 to access the data store to obtain network connections of the first member. The network connections comprise first-degree connections and second-degree connections of the first member. The accessing comprises operations to obtain the list of first-degree connections of the first member, obtaining the lists of first-degree connections of the first-degree connections from the data store, and generating a list of second degree-connections of the first member based on the lists of first-degree connections of the first-degree connections.

From operation 1006, the method 1000 flows to operation 1008 to determine, for each network connection of the first member, if the resource is relevant for the network connection based on the member information retrieved from the data store.

From operation 1008, the method 1000 flows to operation 1010 to generate a notification about the resource for one or more of the network connections based on a relevance of the resource to the network connection.

In some examples, obtaining the lists of first-degree connections of the first-degree connections includes making a plurality of batch calls to the data store, each batch call obtaining the second-degree connections obtained via a group from the list of first-degree connections.

In one example, accessing at least one database to collect member information further comprises obtaining the first-degree connections from a first database storing social graph information; for each first-degree connection, obtaining the information about the first-degree connection from a second database storing information about members of the online service; and generating the list of first-degree connections.

In one example, the information about each first-degree connection comprises a job-seeker score and one or more title identifiers (IDs).

In one example, the job-seeker score is a relevance score indicating a job-seeking status of the network connection, the job-seeker score being calculated by a machine learning model based on profile information and members' job seeking activities (e.g., job views, job applications submitted).

In one example, determining if the resource is relevant comprises determining that the resource is relevant based on the job-seeker score and the one or more title identifiers (IDs).

In one example, the job-seeker score is based on a job-affinity score.

In one example, the method 1000 further comprises providing a user interface (UI) to present resources for a given member, each resource providing an indication if the resource is sponsored by a network connection of the given member.

In one example, the notification is one of a badge notification, a push notification, or an email.

In view of the disclosure above, various examples are set forth below. It should be noted that one or more features of an example, taken in isolation or combination, should be considered within the disclosure of this application.

Another general aspect is for a system that includes a memory comprising instructions and one or more computer processors. The instructions, when executed by the one or more computer processors, cause the one or more computer processors to perform operations comprising: accessing at least one database to collect member information for at least one member of an online service, the member information comprising information on first-degree connections of the at least one member and information about each first-degree connection; storing in a data store, for at least one member, a list of first-degree connections of the at least one member and information about each first-degree connection; detecting a resource associated with a first member in the online service; accessing the data store to obtain network connections of the first member, the network connections comprising first-degree connections and second-degree connections of the first member, the accessing comprising: obtaining the list of first-degree connections of the first member; and for each first-degree connection, obtaining a list of second-degree connections of the first member by requesting the list of first-degree connections of the first-degree connection from the data store; for each network connection of the first member, determining if the resource is relevant for the network connection based on the member information retrieved from the data store; and generating a notification about the resource for one or more of the network connections based on a relevance of the resource to the network connection.

In yet another general aspect, a tangible machine-readable storage medium (e.g., a non-transitory storage medium) includes instructions that, when executed by a machine, cause the machine to perform operations comprising: accessing at least one database to collect member information for at least one member of an online service, the member information comprising information on first-degree connections of the at least one member and information about each first-degree connection; storing in a data store, for at least one member, a list of first-degree connections of the at least one member and information about each first-degree connection; detecting a resource associated with a first member in the online service; accessing the data store to obtain network connections of the first member, the network connections comprising first-degree connections and second-degree connections of the first member, the accessing comprising: obtaining the list of first-degree connections of the first member; and for each first-degree connection, obtaining a list of second-degree connections of the first member by requesting the list of first-degree connections of the first-degree connection from the data store; for each network connection of the first member, determining if the resource is relevant for the network connection based on the member information retrieved from the data store; and generating a notification about the resource for one or more of the network connections based on a relevance of the resource to the network connection.

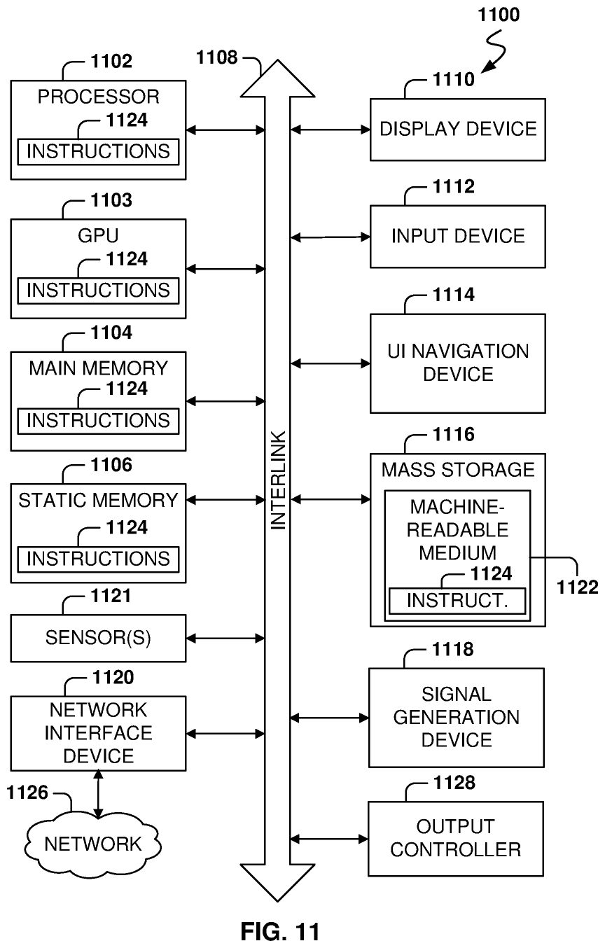

FIG. 11 is a block diagram illustrating an example of a machine 1100 upon or by which one or more example process embodiments described herein may be implemented or controlled. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in a peer-to-peer (P2P) (or other distributed) network environment. Further, while only a single machine 1100 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1100 may include a hardware processor 1102 (e.g., a central processing unit (CPU), a hardware processor core, or any combination thereof), a graphics processing unit (GPU) 1103, a main memory 1104, and a static memory 1106, some or all of which may communicate with each other via an interlink (e.g., bus) 1108. The machine 1100 may further include a display device 1110, an alphanumeric input device 1112 (e.g., a keyboard), and a user interface (UI) navigation device 1114 (e.g., a mouse). In an example, the display device 1110, alphanumeric input device 1112, and UI navigation device 1114 may be a touch screen display. The machine 1100 may additionally include a mass storage device (e.g., drive unit) 1116, a signal generation device 1118 (e.g., a speaker), a network interface device 1120, and one or more sensors 1121, such as a Global Positioning System (GPS) sensor, compass, accelerometer, or another sensor. The machine 1100 may include an output controller 1128, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1116 may include a machine-readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, within the hardware processor 1102, or within the GPU 1103 during execution thereof by the machine 1100. In an example, one or any combination of the hardware processor 1102, the GPU 1103, the main memory 1104, the static memory 1106, or the mass storage device 1116 may constitute machine-readable media.

While the machine-readable medium 1122 is illustrated as a single medium, the term “machine-readable medium” may include a single medium, or multiple media, (e.g., a centralized or distributed database, and/or associated caches and servers) configured to store the one or more instructions 1124.

The term “machine-readable medium” may include any medium that is capable of storing, encoding, or carrying instructions 1124 for execution by the machine 1100 and that cause the machine 1100 to perform any one or more of the techniques of the present disclosure, or that is capable of storing, encoding, or carrying data structures used by or associated with such instructions 1124. Non-limiting machine-readable medium examples may include solid-state memories, and optical and magnetic media. In an example, a massed machine-readable medium comprises a machine-readable medium 1122 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device 1120.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
accessing at least one database to collect member information for at least one member of an online service, the member information comprising first-degree connections of the at least one member and information about each first-degree connection;
storing in a data store, for the at least one member, a list of first-degree connections of the at least one member and information about each first-degree connection;
detecting a resource associated with a first member in the online service;
accessing the data store to obtain network connections of the first member, the network connections comprising first-degree connections and second-degree connections of the first member, the accessing comprising:
obtaining the list of first-degree connections of the first member;
obtaining the lists of first-degree connections of the first-degree connections from the data store; and
generating a list of second degree-connections of the first member based on the lists of first-degree connections of the first-degree connections;
for each network connection of the first member, determining if the resource is relevant for the network connection based on the member information retrieved from the data store; and
generating a notification about the resource for one or more of the network connections based on a relevance of the resource to the network connection.

2. The method as recited in claim 1, wherein obtaining the lists of first-degree connections of the first-degree connections includes:
making a plurality of batch calls to the data store, each batch call obtaining the second-degree connections obtained via a group from the list of first-degree connections.

3. The method as recited in claim 1, wherein accessing at least one database to collect member information further comprises:
obtaining the first-degree connections from a first database storing social graph information;
for each first-degree connection, obtaining the information about the first-degree connection from a second database storing information about members of the online service; and
generating the list of first-degree connections.

4. The method as recited in claim 3, wherein the information about each first-degree connection comprises a job-seeker score and one or more title identifiers (IDs).

5. The method as recited in claim 4, wherein the job-seeker score is a relevance score indicating a job-seeking status of the network connection, the job-seeker score being calculated by a machine learning model based on profile information and job post activities.

6. The method as recited in claim 4, wherein determining if the resource is relevant comprises:
determining that the resource is relevant based on the job-seeker score and the one or more title identifiers (IDs).

7. The method as recited in claim 4, wherein the job-seeker score is based on a job-affinity score.

8. The method as recited in claim 1, further comprising:
providing a user interface (UI) to present resources for a given member, each resource providing an indication if the resource is sponsored by a network connection of the given member.

9. The method as recited in claim 1, wherein the notification is one of a badge notification, a push notification, or an email.

10. A system comprising:
a memory comprising instructions; and
one or more computer processors, wherein the instructions, when executed by the one or more computer processors, cause the system to perform operations comprising:
accessing at least one database to collect member information for at least one member of an online service, the member information comprising first-degree connections of the at least one member and information about each first-degree connection;
storing in a data store, for the at least one member, a list of first-degree connections of the at least one member and information about each first-degree connection;
detecting a resource associated with a first member in the online service;
accessing the data store to obtain network connections of the first member, the network connections comprising first-degree connections and second-degree connections of the first member, the accessing comprising:
obtaining the list of first-degree connections of the first member;
obtaining the lists of first-degree connections of the first-degree connections from the data store; and
generating a list of second degree-connections of the first member based on the lists of first-degree connections of the first-degree connections;
for each network connection of the first member, determining if the resource is relevant for the network connection based on the member information retrieved from the data store; and
generating a notification about the resource for one or more of the network connections based on a relevance of the resource to the network connection.

11. The system as recited in claim 10, wherein obtaining the lists of first-degree connections of the first-degree connections includes:
making a plurality of batch calls to the data store, each batch call obtaining the second-degree connections obtained via a group from the list of first-degree connections.

12. The system as recited in claim 10, wherein accessing at least one database to collect member information further comprises:
obtaining the first-degree connections from a first database storing social graph information;
for each first-degree connection, obtaining the information about the first-degree connection from a second database storing information about members of the online service; and
generating the list of first-degree connections.

13. The system as recited in claim 12, wherein the information about each first-degree connection comprises a job-seeker score and one or more title identifiers (IDs).

14. The system as recited in claim 13, wherein the job-seeker score is a relevance score indicating a job-seeking status of the network connection, the job-seeker score being calculated by a machine learning model based on profile information and job post activities.

15. A tangible machine-readable storage medium including instructions that, when executed by a machine, cause the machine to perform operations comprising:
accessing at least one database to collect member information for at least one member of an online service, the member information comprising first-degree connections of the at least one member and information about each first-degree connection;
storing in a data store, for the at least one member, a list of first-degree connections of the at least one member and information about each first-degree connection;
detecting a resource associated with a first member in the online service;
accessing the data store to obtain network connections of the first member, the network connections comprising first-degree connections and second-degree connections of the first member, the accessing comprising:
obtaining the list of first-degree connections of the first member;
obtaining the lists of first-degree connections of the first-degree connections from the data store; and
generating a list of second degree-connections of the first member based on the lists of first-degree connections of the first-degree connections;
for each network connection of the first member, determining if the resource is relevant for the network connection based on the member information retrieved from the data store; and
generating a notification about the resource for one or more of the network connections based on a relevance of the resource to the network connection.

16. The tangible machine-readable storage medium as recited in claim 15, wherein obtaining the lists of first-degree connections of the first-degree connections includes:
making a plurality of batch calls to the data store, each batch call obtaining the second-degree connections obtained via a group from the list of first-degree connections.

17. The tangible machine-readable storage medium as recited in claim 15, wherein accessing at least one database to collect member information further comprises:
obtaining the first-degree connections from a first database storing social graph information;
for each first-degree connection, obtaining the information about the first-degree connection from a second database storing information about members of the online service; and
generating the list of first-degree connections.

18. The tangible machine-readable storage medium as recited in claim 17, wherein the information about each first-degree connection comprises a job-seeker score and one or more title identifiers (IDs).

19. The tangible machine-readable storage medium as recited in claim 18, wherein the job-seeker score is a relevance score indicating a job-seeking status of the network connection, the job-seeker score being calculated by a machine learning model based on profile information and job post activities.

20. The tangible machine-readable storage medium as recited in claim 18, wherein determining if the resource is relevant comprises:
determining that the resource is relevant based on the job-seeker score and the one or more title identifiers (IDs).
